(19) United States
(12) Patent Application Publication
(10) Pub. No.: US 2024/0322206 A1
(43) Pub. Date: Sep. 26, 2024

(54) FUEL CELL SYSTEM

(71) Applicant: SUBARU CORPORATION, Tokyo (JP)

(72) Inventors: Pei PEI, Tokyo (JP); Takumi NUNOKAWA, Tokyo (JP)

(73) Assignee: SUBARU CORPORATION, Tokyo (JP)

(21) Appl. No.: 18/591,147

(22) Filed: Feb. 29, 2024

(30) Foreign Application Priority Data
Mar. 22, 2023 (JP) 2023-045274

(51) Int. Cl. H01M 8/04828; H01M 8/04111; H01M 8/04119; H01M 8/0432; H01M 8/04746; H01M 8/10

(52) U.S. Cl. CPC H01M 8/04835; H01M 8/04111; H01M 8/04179; H01M 8/0432; H01M 8/04753; H01M 8/04776; H01M 2008/1095

(57) ABSTRACT

A fuel cell system includes: an anode gas intake path that is linked to a hydrogen circulation path to feed anode gas to an anode of a fuel cell; an anode gas discharge path linked to the anode; a cathode gas intake path for feeding cathode gas to a cathode of the fuel cell; a cathode gas discharge path linked to the cathode; a bypass flow path that links the hydrogen circulation path to the cathode gas intake path and/or the cathode gas discharge path; a circulating pump on the hydrogen circulation path; on-off valves on the anode gas intake path, the anode gas discharge path, and the bypass flow path; and a control device configured to control the on-off valves and the circulating pump. The control device is configured to cause the circulating pump to rotate in a normal or reverse direction selectively to discharge water or water vapor.

### CROSS-REFERENCE TO RELATED APPLICATION

The present application claims priority from Japanese Patent Application No. 2023-045274 filed on Mar. 22, 2023, the entire contents of which are hereby incorporated by reference.

### BACKGROUND

The disclosure relates to a fuel cell system to be applied to, for example, a vehicle.

A typical fuel cell system includes two electrodes including a fuel electrode and an air electrode, and produces electric energy by the reaction of hydrogen gas fed to the fuel electrode and oxygen gas fed to the air electrode.

In some cases, gas discharged from the cathode (also referred to as cathode off-gas) as a result of the fuel cell reaction contains moisture, and/or moisture produced by the fuel cell reaction remains on the anode side. For example, such a fuel cell is used in a low-temperature environment where the moisture in the gas and/or the water residue can condense or freeze within the fuel cell. Proposed preventive measures include scavenging disclosed in Japanese Unexamined Patent Application Publication (JP-A) No. 2008-186624, which describes a fuel cell system that drains water out of a fuel cell through a path of reactant gas at the time of system shutdown.

### SUMMARY

An aspect of the disclosure provides a fuel cell system including an anode gas intake path, an anode gas discharge path, a cathode gas intake path, a cathode gas discharge path, a bypass flow path, a circulating pump, on-off valves, and a control device. Anode gas is to be fed to an anode of a fuel cell through the anode gas intake path. The anode gas intake path is linked to a hydrogen circulation path. The anode gas discharge path is linked to the anode. Cathode gas is to be fed to a cathode of the fuel cell through the cathode gas intake path. The cathode gas discharge path is linked to the cathode. The bypass flow path links the hydrogen circulation path to the cathode gas intake path and/or the cathode gas discharge path. The circulating pump is disposed on the hydrogen circulation path. The on-off valves include an on-off valve on the anode gas intake path, an on-off valve on the anode gas discharge path, and an on-off valve on the bypass flow path. The control device is configured to control the on-off valves and operation of the circulating pump. The control device is configured to cause the circulating pump to rotate in a normal direction or a reverse direction in a selective manner during control of the on-off valves to discharge water or water vapor out of the fuel cell.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a block diagram illustrating a fuel cell system according to an embodiment;

FIG. 2 schematically illustrates the circulation of gas in an anode-side flow path during normal pump rotation in which a circulating pump rotates in the normal direction;

FIG. 3 schematically illustrates the circulation of gas in the anode-side flow path during reverse pump rotation in which the circulating pump rotates in the reverse direction;

FIG. 4 is a block diagram of a fuel cell system according to an embodiment involving the parallel connection of an anode-side flow path and a cathode-side flow path and schematically illustrates the circulation of gas during the normal pump rotation in which the circulating pump rotates in the normal direction;

FIG. 5 is a functional block diagram including an electronic control unit (ECU) that is a control device according to the embodiment of the disclosure;

FIG. 6 is a block diagram of the fuel cell system according to the embodiment involving the parallel connection of the anode-side flow path and the cathode-side flow path and schematically illustrates the circulation of gas during the reverse pump rotation in which the circulating pump rotates in the reverse direction; and

FIG. 7 is a block diagram of a fuel cell system according to an embodiment involving the series connection of an anode-side flow path and a cathode-side flow path.

### DETAILED DESCRIPTION

The current technology including the approach proposed in JP-A No. 2008-186624 has not yet successfully meet the demands of the marketplace, and the following issues remain unaddressed.

For example, JP-A No. 2008-186624 indicates that internal pressure pulsations of a circulation path provided with a hydrogen pump for recirculating anode off-gas into a fuel gas flow path enable removal of stagnant moisture in the gas flow path.

Although moisture can be removed to some extent, this system has not reached to a point where moisture remaining in, for example, the fuel cell can be more easily and efficiently removed; therefore, the approach proposed in JP-A No. 2008-186624 still has a lot of room for improvement.

It is desirable to provide a fuel cell system that makes it possible to remove moisture residue in, for example, a fuel cell more easily and efficiently.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. Features that will be described in detail below may be supplemented as appropriate by constituent technologies and features adopted in known fuel cell systems including the one described in JP-A No. 2008-186624.

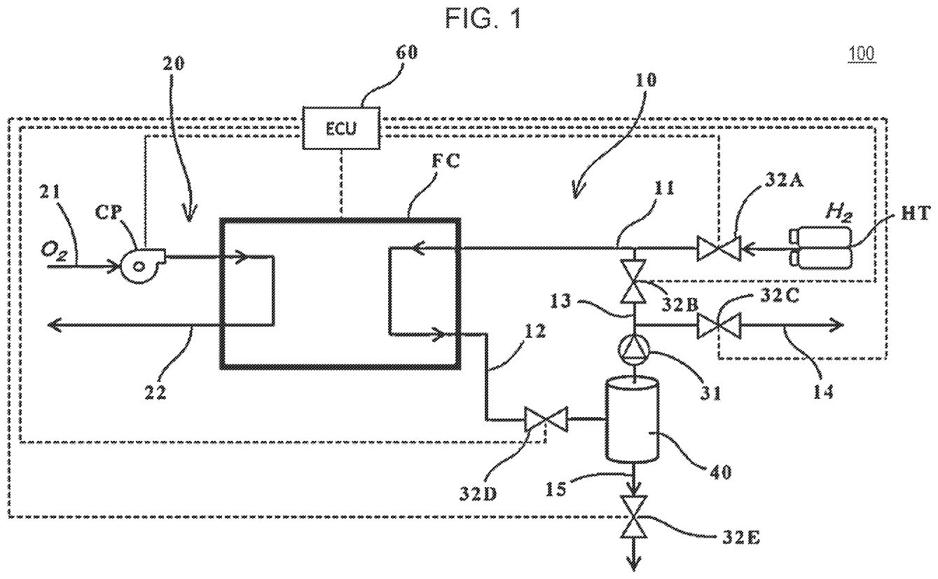

A fuel cell system 100 according to a preferred embodiment of the disclosure is described below with reference to FIG. 1. The fuel cell system 100 according to the present embodiment is to be installed on a known fuel cell vehicle (FCV) equipped with, for example, a known hydrogen tank (HT) and a known fuel cell (FC).

The fuel cell system 100 to be installed on an FCV includes the FC, a gas intake-discharge path, and a control device 60. The FC is supplied with anode gas and cathode gas fed through the gas intake-discharge path. The control device 60 is an electronic control unit (ECU) that controls the operation of the FC.

The FC is not limited to a particular type of fuel cell and may be any type of fuel cell to which a moisture removal technique described herein is applicable. For example, the FC may be a polymer electrolyte fuel cell (PEFC) or any other known fuel cell. Various kinds of known on-board electronic modules (EMs), such as a DC-DC converter, an inverter, a battery, and/or an electric motor, are coupled to the FC.

The following describes the gas intake-discharge path in the present embodiment with reference to FIGS. 1 to 3. Anode gas and cathode gas are fed to the FC through the gas intake-discharge path and anode off-gas and cathode off-gas are discharged from the FC through the gas intake-discharge path.

Referring to FIG. 1, the gas intake-discharge path in the present embodiment includes an anode-side flow path 10 and a cathode-side flow path 20, which are located on the anode side and the cathode side, respectively, of the FC. The anode-side flow path 10 includes an anode gas intake path 11, an anode gas discharge path 12, a hydrogen circulation path 13, and an open-to-atmosphere discharge flow path 14. The cathode-side flow path 20 includes a cathode gas intake path 21 and a cathode gas discharge path 22. The gas intake-discharge path in the present embodiment includes, in addition to the anode-side flow path 10 and the cathode-side flow path 20, a bypass flow path 50, which forms a link between them as appropriate. For example, the bypass flow path 50 links the hydrogen circulation path 13 to the cathode gas intake path 21 and/or the cathode gas discharge path 22.

As can be understood from FIG. 1, the hydrogen circulation path 13 in the present embodiment is provided with a circulating pump 31, which can apply a desired level of pressure to the fluid in the anode gas intake path 11 and the fluid in the anode gas discharge path 12. The circulating pump 31 under the control of the control device 60 is capable of rotating in the normal direction or the reverse direction at the appropriate time. The control device 60 will be described later.

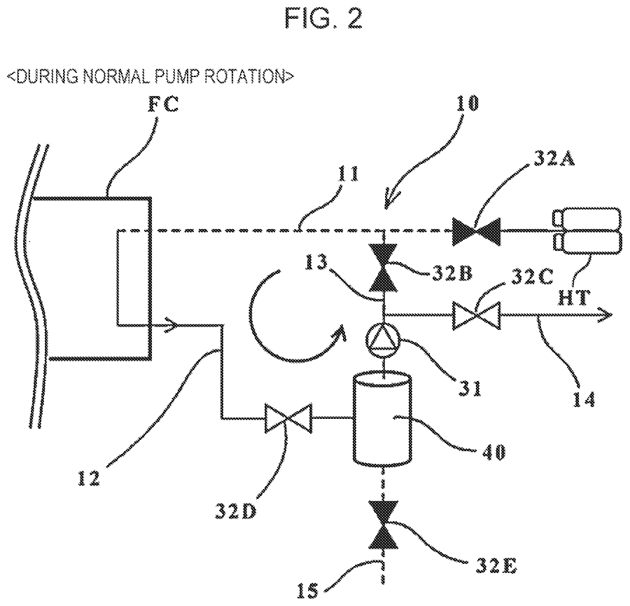

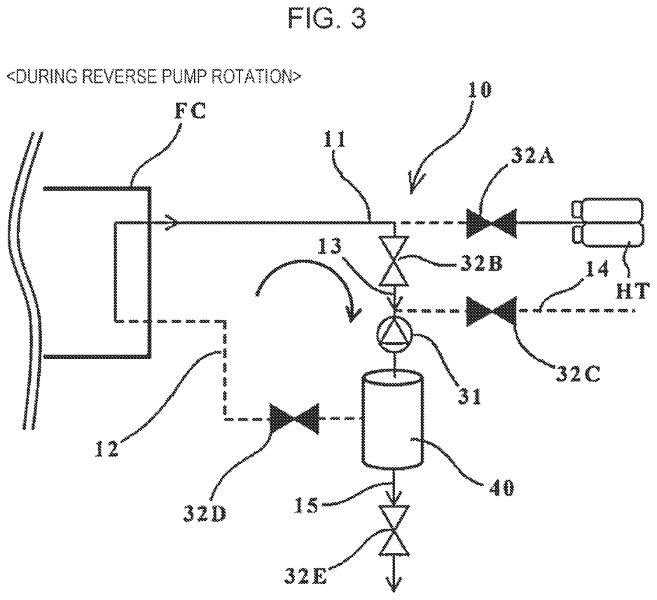

When driven to rotate in the normal direction, the circulating pump 31 causes gas to flow to the anode of the FC through the hydrogen circulation path 13 and the anode gas intake path 11, as illustrated in FIG. 2. When driven to rotate in the reverse direction, the circulating pump 31 causes gas to flow to a vapor-liquid separator 40 through the anode gas intake path 11 and the hydrogen circulation path 13, as illustrated FIG. 3.

For example, the circulating pump 31 is a known three-phase induction electric motor. Switching between normal pump rotation and reverse pump rotation involves, as appropriate, reversing the direction of rotation of the three-phase induction electric motor by, for example, appropriate interchange of motor leads corresponding to any two of the three phases for a three-phase alternating-current power supply. Pumps capable of switching between the normal rotation and the reverse rotation are disclosed in, for example, JP-A No. 2006-063850, JP-A No. 10-103291, JP-A No. 2020-118123, and JP-A No. 2008-267358. Such a known pump may be adopted as the circulating pump 31 capable of switching between the normal rotation and the reverse rotation as appropriate.

Anode gas (hydrogen gas) is fed to the anode of the FC through the anode gas intake path 11, which is linked to the hydrogen circulation path 13. The anode gas intake path 11 is linked to a hydrogen tank HT, which is a known hydrogen tank and filled with hydrogen gas. The anode gas intake path 11 is provided with a first on-off valve 32A, which is open or closed to adjust the amount of hydrogen gas to be supplied from the hydrogen tank HT. The first on-off valve 32A will be described later.

The anode gas discharge path 12 is linked to the anode of the FC. Anode off-gas discharged from the FC and containing moisture flows through the anode gas discharge path 12. The anode gas discharge path 12 is provided with a fourth on-off valve 32D and a vapor-liquid separator 40. The fourth on-off valve 32D is for use in interrupting the flow of fluid in the anode gas discharge path 12 as appropriate. The vapor-liquid separator 40 is a known vapor-liquid separator and is capable of separating gas and liquid from the anode off-gas. The anode off-gas discharged from the FC is introduced through the fourth on-off valve 32D into vapor-liquid separator 40, where excess moisture is removed.

As illustrated in FIGS. 1 to 3, a moisture discharge path 15 is linked to the vapor-liquid separator 40. The moisture discharge path 15 is a known moisture discharge path. The moisture separated by the vapor-liquid separator 40 flows through the moisture discharge path 15 and is then discharged out of the system. The moisture discharge path 15 is provided with a fifth on-off valve 32E. The moisture separated from the anode off-gas by the vapor-liquid separator 40 is discharged from the moisture discharge path 15 through the fifth on-off valve 32E as appropriate.

The hydrogen circulation path 13 forms a link between the vapor-liquid separator 40 and the anode gas intake path 11. The hydrogen circulation path 13 is provided with a second on-off valve 32B, which is for use in adjusting the amount of hydrogen gas to be introduced into the anode gas intake path 11. Hydrogen that is separated from the anode off-gas by the vapor-liquid separator 40 and is yet to be used flows back into the anode gas intake path 11 through the second on-off valve 32B and is thus referred to as circulating hydrogen.

The open-to-atmosphere discharge flow path 14 is linked to the hydrogen circulation path 13. The circulating hydrogen diverted from the hydrogen circulation path 13 flows through the open-to-atmosphere discharge flow path 14 and is then discharged out of the system and released into, for example, the atmosphere. The open-to-atmosphere discharge flow path 14 is provided with a third on-off valve 32C, which is for use in adjusting the amount of hydrogen gas to be diverted from the hydrogen circulation path 13 and introduced into open-to-atmosphere discharge flow path 14.

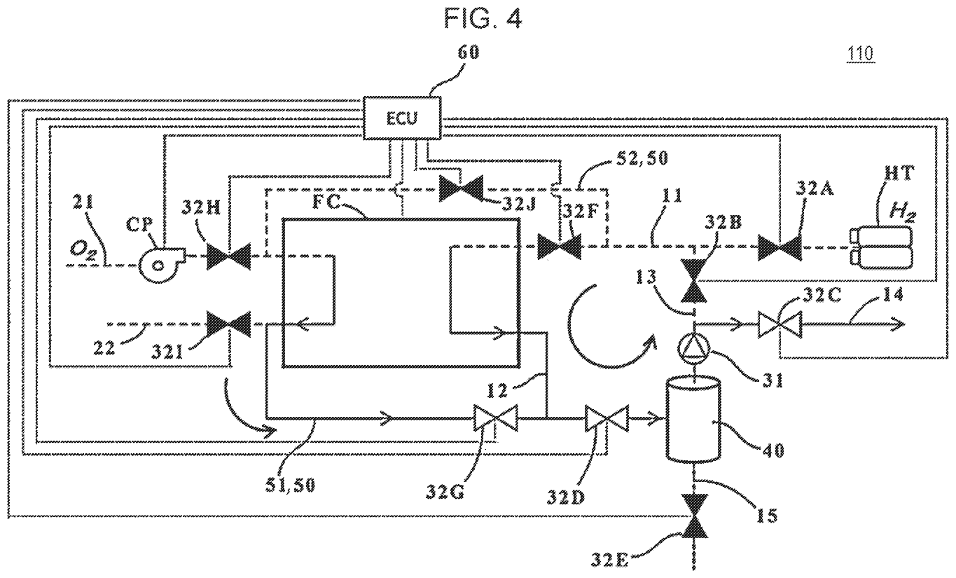

The cathode gas (air) is fed to the cathode of the FC through the cathode gas intake path 21. The cathode gas intake path 21 is provided with a known air filter (not illustrated) and an air compressor (CP) (see FIG. 1) that are capable of introducing cathode gas into the FC. As will be described later with reference to FIG. 4, the cathode gas intake path 21 may be provided with an eighth on-off valve 32H, which is for use in adjusting the amount of flow of cathode gas in the cathode gas intake path 21.

The cathode gas discharge path 22 is linked to the cathode of the FC. Cathode off-gas flows through the cathode gas discharge path 22. As will be described later with reference to FIG. 4, the cathode gas discharge path 22 may be provided with a ninth on-off valve 32I, which is for use in adjusting the amount of flow of cathode off-gas in the cathode gas discharge path 22.

For example, a known humidifier for humidifying the cathode gas to be fed to the FC may be optionally included. A water vapor exchange membrane that enables the reuse of moisture in exhaust gas may be used to humidify the air to be fed to the FC. Alternatively, the air may be humidified with moisture such as pure water supplied by a known device, such as a membrane humidifier or an atomizer.

The following describes, with reference to FIG. 2, the circulation of gas in the anode-side flow path 10 during normal pump rotation in the course of scavenging in the fuel cell system 100. The normal pump rotation refers to the state in which the circulating pump 31 rotates in the normal direction. For example, the control device 60 operates in a first scavenging mode when the operation of the fuel cell system 100 is temporarily stopped. As described below, scavenging in the first scavenging mode is the process of removing the moisture residue by the application of negative pressure produced in the FC and the flow paths.

Referring to FIG. 2, the control device 60 in the first scavenging mode causes the circulating pump 31 to rotate in the normal direction to remove, for example, moisture remaining in the anode of the FC. The first on-off valve 32A, the second on-off valve 32B, and the fifth on-off valve 32E are closed, and the third on-off valve 32C and the fourth on-off valve 32D are open under the control of the control device 60, as illustrated in FIG. 2.

In this state, the circulating pump 31 is caused to rotate in the normal direction. As a result, the anode of the FC is cut off from a new supply of hydrogen gas (fresh gas) conveyed through the anode gas intake path 11, and anode off-gas, moisture, and the like in the anode of the FC flow through the anode gas discharge path 12 under a predetermined negative pressure and are then introduced into the vapor-liquid separator 40. The anode off-gas introduced into the vapor-liquid separator 40 flows through the hydrogen circulation path 13 and the open-to-atmosphere discharge flow path 14 and is then discharged into the atmosphere.

The following describes, with reference to FIG. 3, the circulation of gas in the anode-side flow path 10 during reverse pump rotation in the course of scavenging in the fuel cell system 100. The reverse pump rotation refers to the state in which the circulating pump 31 rotates in the reverse direction. For example, the control device 60 operates in a second scavenging mode when the operation of the fuel cell system 100 is temporarily stopped, as mentioned above in relation to the first scavenging mode. As described below, scavenging in the second scavenging mode is the process of removing the moisture residue by the application of negative pressure produced in the FC and the flow paths.

Referring to FIG. 3, the control device 60 in the second scavenging mode causes the circulating pump 31 to rotate in the reverse direction to remove, for example, moisture remaining in the anode of the FC. Under the control of the control device 60, the first on-off valve 32A, the third on-off valve 32C, and the fourth on-off valve 32D are closed, and the second on-off valve 32B and the fifth on-off valve 32E are open, as illustrated in FIG. 3.

In this state, the circulating pump 31 is caused to rotate in the reverse direction. As a result, the new supply of hydrogen gas from the hydrogen tank HT is cut off, and anode off-gas is not discharged from the FC trough the anode gas discharge path 12. Meanwhile, anode off-gas, moisture, and the like in the anode of the FC flow through the anode gas intake path 11 and the hydrogen circulation path 13 under a predetermined negative pressure and are then introduced into the vapor-liquid separator 40. The water in the anode off-gas introduced into the vapor-liquid separator 40 flows through the moisture discharge path 15 and is then discharged into the atmosphere.

The control device 60 may switch between the first scavenging mode and the second scavenging mode for removal of moisture residue (water or water vapor) in the FC as appropriate when predetermined conditions are satisfied.

That is, the control device 60 in the present embodiment is capable of operating in the first scavenging mode or the second scavenging mode for removal of moisture residue in the FC when, for example, the operation of the fuel cell system 100 is temporarily stopped. In other words, the control device 60 controls the on-off valves 32 and causes the circulating pump 31 to rotate in the normal or reverse direction in a selective manner such that water or water vapor is discharged out of the FC.

A fuel cell system 110 according to a second embodiment of the disclosure is described below with reference to FIG. 4.

The fuel cell system 110 according to the present embodiment includes, the constituent components described above in relation to the fuel cell system 100 according to the first embodiment, the bypass flow path 50, which forms a link between the anode-side flow path 10 and the cathode-side flow path 20.

The anode gas intake path 11 in the fuel cell system 110 is provided with a sixth on-off valve 32F, which is disposed on the anode gas intake path 11. The sixth on-off valve 32F is located between the FC and a junction of the anode gas intake path 11 and the hydrogen circulation path 13. The cathode gas intake path 21 in the fuel cell system 110 is provided with the eighth on-off valve 32H. The cathode gas discharge path 22 in the fuel cell system 110 is provided with the ninth on-off valve 32I.

Referring to FIG. 4, the bypass flow path 50 in the present embodiment includes a first bypass flow path 51 and a second bypass flow path 52.

The first bypass flow path 51 forms a link between a first point on the cathode gas discharge path 22 and a second point on the anode gas discharge path 12. The first point is located between the FC and the ninth on-off valve 32I. The second point is located between the FC and the fourth on-off valve 32D. In other words, the bypass flow path 50 in the present embodiment serves as a link between the hydrogen circulation path 13 and the cathode gas discharge path 22.

The first bypass flow path 51 is provided with a seventh on-off valve 32G. The seventh on-off valve 32G is for use in adjusting the circulation of gas flowing from the anode-side flow path 10 into the cathode-side flow path 20, and vice versa, through the first bypass flow path 51. As can be understood from FIG. 4, the first bypass flow path 51 in the present embodiment is provided so that the anode-side flow path 10 and the cathode-side flow path 20 are connected in parallel to the hydrogen circulation path 13 and the vapor-liquid separator 40.

The second bypass flow path 52 is a bypass flow path different from the first bypass flow path 51 and forms a link between a third point on the cathode gas intake path 21 and a fourth point on the anode gas intake path 11. The third point is located between the FC and the eighth on-off valve 32H. The fourth point is located between the first on-off valve 32A and the sixth on-off valve 32F. In other words, the bypass flow path 50 in the present embodiment serves as a link between the hydrogen circulation path 13 and the cathode gas intake path 21.

The second bypass flow path 52 is provided with a tenth on-off valve 32J. The tenth on-off valve 32J is for use in adjusting the circulation of gas flowing from the anode-side flow path 10 into the cathode-side flow path 20, and vice versa, through the second bypass flow path 52. As can be understood from FIG. 4, the second bypass flow path 52 in the present embodiment is similar to the first bypass flow path 51 and is provided so that the anode-side flow path 10 and the cathode-side flow path 20 are connected in parallel to the hydrogen circulation path 13 and the vapor-liquid separator 40.

As described above, the fuel cell system 110 according to the present embodiment includes the on-off valves 32 (the first on-off valve 32A to the tenth on-off valve 32J) on the anode gas intake path 11, the anode gas discharge path 12, the cathode gas intake path 21, the cathode gas discharge path 22, and the bypass flow path 50 (the first bypass flow path 51 and the second bypass flow path 52).

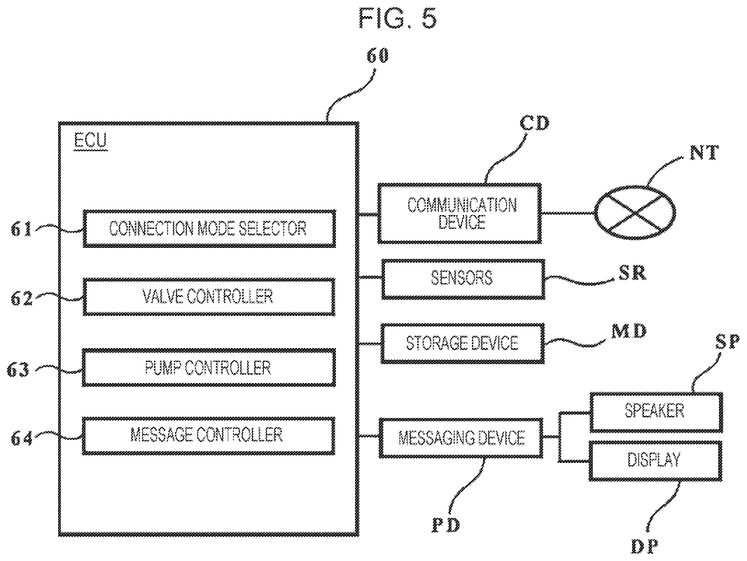

The control device 60 controls the opening and closing of each of the on-off valves 32. Referring to FIG. 5, the control device 60 in the present embodiment includes, for example, a connection mode selector 61, a valve controller 62, a pump controller 63, and a message controller 64. For example, the control device 60 is a known computer including one or more processors such as a known central processing unit (CPU) and one or more memories communicably connected to the one or more processors.

The control device 60 in the present embodiment may be configured to exercise overall control of the fuel cell system 110. As illustrated in FIG. 5, the control device 60 in the present embodiment may be connected to an external network NT by a communication device CD. The external network NT is a known network, such as the Internet. For example, the communication device CD is a known on-vehicle communication device that enables information communications between the FCV and an external server. Examples of the external network NT are not limited to the Internet and include known information communication network available for use in carrying out intervehicle communications involving transmission and reception of various kinds of information through, for example, wireless communications.

The control device 60 is capable of receiving various kinds of signals from sensors SR, which are installed on the FCV. Examples of the sensors SR include known various on-vehicle sensors, such as an outside air temperature sensor and a vehicle speed sensor that are normally installed on a vehicle to measure the outside temperature and the vehicle speed, respectively. The control device 60 is capable of communicating with a messaging device PD, which is installed on the FCV. The messaging device PD is a known messaging device including, for example, a known on-vehicle speaker and a known on-vehicle display, which are herein denoted by SP and DP, respectively.

The control device 60 is electrically connected to a storage device MD, which is a known storage device and is installed on the FCV. Examples of the storage device MD include: magnetic media such as hard disks, floppy disks, and magnetic tapes; optical recording media such as compact disk read-only memory (CD-ROM), digital versatile disks (DVDs), and Blu-ray (registered trademark); magneto-optical recording media such as floptical disks: storage cells such as RAM and ROM; flush memory such as universal serial bus (USB) memory; solid-state drives (SSDs); and any other media in which programs can be stored.

The connection mode selector 61 enables selection between connection patterns of the anode-side flow path 10 and the cathode-side flow path 20 and also enables switching between the scavenging modes in the present disclosure as appropriate. As described below, the connection mode selector 61 is capable of causing a change from series to parallel connection, and vice versa, of the anode-side flow path 10 and the cathode-side flow path 20 based on, for example, the information about the outside air temperature.

The switching between the series connection and the parallel connection may be performed based on the information about the outside air temperature in the following manner: (i) when the outside air temperature is below the freezing point, the removal of moisture is of paramount importance in light of prevention of freezing; therefore, the anode-side flow path and the cathode-side flow path are connected in parallel so that negative pressure is produced on both the anode side and the cathode side to discharge moisture; and (ii) when there is little possibility of freezing, matters to be addressed include both the removal of moisture and the inhibition of oxidation and corrosion of a catalyst in the FC; therefore, the anode-side flow path and the cathode-side flow path are connected in series so that moisture on the anode side is discharged by way of the cathode side.

The valve controller 62 is configured to control the on-off valves 32 (the first on-off valve 32A to the tenth on-off valve 32J). The valve controller 62 is capable of, for example, causing a change from series to parallel connection, and vice versa, of the anode-side flow path 10 and the cathode-side flow path 20 in accordance with the connection mode selected by the connection mode selector 61.

The pump controller 63 is configured to control the operation of the circulating pump 31. The pump controller 63 causes the circulating pump 31 to rotate in the normal direction or the reverse direction in accordance with the connection mode selected by the connection mode selector 61.

The message controller 64 is configured to cause the messaging device PD (the on-vehicle speaker SP and the on-vehicle display DP) to impart various kinds of information. For example, the user (occupant) of the FCV can determine, based on the information, whether the FC in the fuel cell system 110 is undergoing scavenging.

Normal Rotation Mode Involving Parallel Connection of Anode-Side Flow Path and Cathode-Side Flow Path

The following describes a third scavenging mode in the present embodiment with reference to FIG. 4. The third scavenging mode is the normal rotation mode involving the parallel connection of the anode-side flow path 10 and the cathode-side flow path 20; that is, the third scavenging mode is enabled by the parallel connection and the normal pump rotation. As illustrated in FIG. 4, the fuel cell system 110 in the present embodiment undergoes scavenging (in the third scavenging mode) in the state in which the circulating pump 31 rotates in the normal direction in the parallel connection mode in which the anode-side flow path 10 and the cathode-side flow path 20 are connected in parallel. For example, the control device 60 operates in the third scavenging mode when the operation of the fuel cell system 110 is temporarily stopped. As described below, scavenging in the third scavenging mode is the process of removing the moisture residue in the system of the FC by the application of negative pressure produced in the FC, the flow paths, and the like.

The first on-off valve 32A, the second on-off valve 32B, the fifth on-off valve 32E, the sixth on-off valve 32F, the eighth on-off valve 32H, the ninth on-off valve 32I, and the tenth on-off valve 32J are closed under the control of the control device 60, as illustrated in FIG. 4. Meanwhile, the third on-off valve 32C, the fourth on-off valve 32D, and the seventh on-off valve 32G are open under the control of the control device 60.

In this state, the circulating pump 31 is caused to rotate in the normal direction. As a result, the anode of the FC is cut off from a new supply of hydrogen gas (fresh gas) conveyed through the anode gas intake path 11, and anode off-gas, moisture, and the like in the anode of the FC flow through the anode gas discharge path 12 under a predetermined negative pressure and are then introduced into the vapor-liquid separator 40. While the anode off-gas and the moisture are introduced into the vapor-liquid separator 40, the cathode is cut off from a new supply of air through the cathode gas intake path 21, and cathode off-gas, moisture, and the like in the cathode of the FC flow through the cathode gas discharge path 22 and the anode gas discharge path 12 under a predetermined negative pressure and are then introduced into the vapor-liquid separator 40.

Under the action of the circulating pump 31 in the third scavenging mode, the anode off-gas containing moisture and the cathode off-gas containing moisture flow through the first bypass flow path 51 and are then introduced into the vapor-liquid separator 40 at the same time. The anode off-gas and the cathode off-gas introduced into the vapor-liquid separator 40 flow through the hydrogen circulation path 13 and the open-to-atmosphere discharge flow path 14 and are then discharged into the atmosphere.

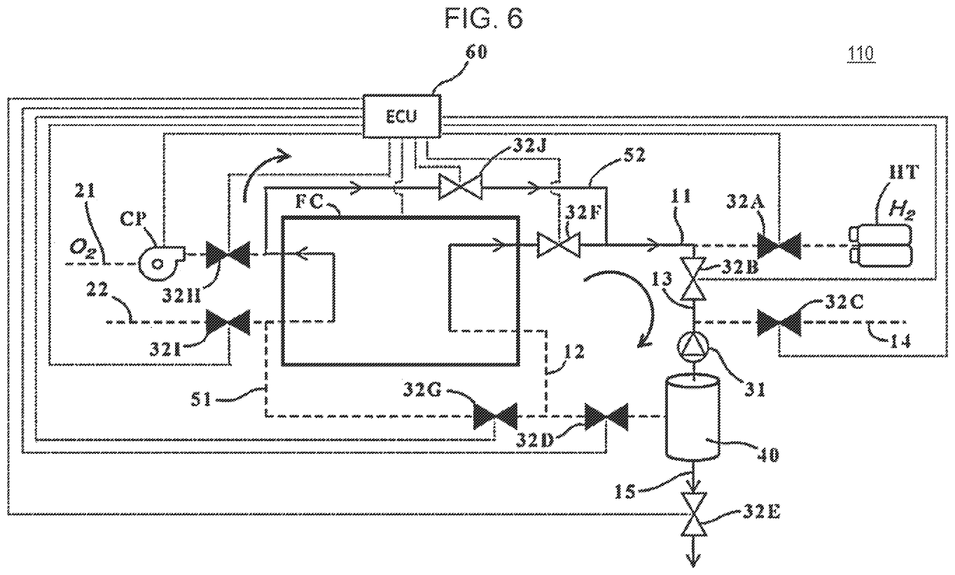

The following describes a fourth scavenging mode in the present embodiment with reference to FIG. 6. The fourth scavenging mode is the reverse rotation mode involving the parallel connection of the anode-side flow path 10 and the cathode-side flow path 20; that is, the fourth scavenging mode is enabled by the parallel connection and the reverse pump rotation. As illustrated in FIG. 6, the fuel cell system 110 in the present embodiment undergoes scavenging (in the fourth scavenging mode) in the state in which the circulating pump 31 rotates in the reverse direction in the parallel connection mode in which the anode-side flow path 10 and the cathode-side flow path 20 are connected in parallel. For example, the control device 60 operates in the fourth scavenging mode when the operation of the fuel cell system 110 is temporarily stopped. As described below, scavenging in the fourth scavenging mode is the process of removing, for example, the moisture residue in the system of the FC by the application of negative pressure produced in the FC and the flow paths.

The first on-off valve 32A, the third on-off valve 32C, the fourth on-off valve 32D, the seventh on-off valve 32G, the eighth on-off valve 32H, and the ninth on-off valve 32I are closed under the control of the control device 60, as illustrated in FIG. 6. Meanwhile, the second on-off valve 32B, the fifth on-off valve 32E, the sixth on-off valve 32F, and the tenth on-off valve 32J are open under the control of the control device 60.

In this state, the circulating pump 31 is caused to rotate in the reverse direction. As a result, the anode of the FC is cut off from a new supply of hydrogen gas (fresh gas) conveyed through the anode gas intake path 11, and anode off-gas and moisture in the anode of the FC flow through the anode gas intake path 11 and the hydrogen circulation path 13 under a predetermined negative pressure and are then introduced into the vapor-liquid separator 40. While the anode off-gas and the moisture are introduced into the vapor-liquid separator 40, the cathode is cut off from a new supply of air conveyed through the cathode gas intake path 21, and cathode off-gas and moisture in the cathode of the FC flow through the cathode gas intake path 21, the second bypass flow path 52, the anode gas intake path 11, and the hydrogen circulation path 13 under a predetermined negative pressure and are then introduced into the vapor-liquid separator 40.

Under the action of the circulating pump 31 in the fourth scavenging mode as well, the anode off-gas containing moisture and the cathode off-gas containing moisture flow through the second bypass flow path 52 and are then introduced into the vapor-liquid separator 40 at the same time. The anode off-gas and the cathode off-gas introduced into the vapor-liquid separator 40 flow through the hydrogen circulation path 13 and the open-to-atmosphere discharge flow path 14 and are then discharged into the atmosphere.

The control device 60 may switch between the third scavenging mode and the fourth scavenging mode for removal of moisture residue in the FC as appropriate when predetermined conditions are satisfied. In this case, the control device 60 selects the bypass flow path 50 (the first bypass flow path 51 or the second bypass flow path 52) by which (a) the anode gas intake path 11 and the cathode gas intake path 21 or (b) the anode gas discharge path 12 and the cathode gas discharge path 22 are connected in parallel.

That is, the fuel cell system 110 in the second embodiment may enter the third scavenging mode or the fourth scavenging mode for removal of moisture residue (water or water vapor) in the FC when, for example, the operation of the fuel cell system 110 is temporarily stopped. In other words, the control device 60 controls the on-off valves 32 and causes the circulating pump 31 to rotate in the normal or reverse direction in a selective manner such that water or water vapor is discharged out of, for example, the FC, the anode gas intake path 11, and the cathode gas intake path 21.

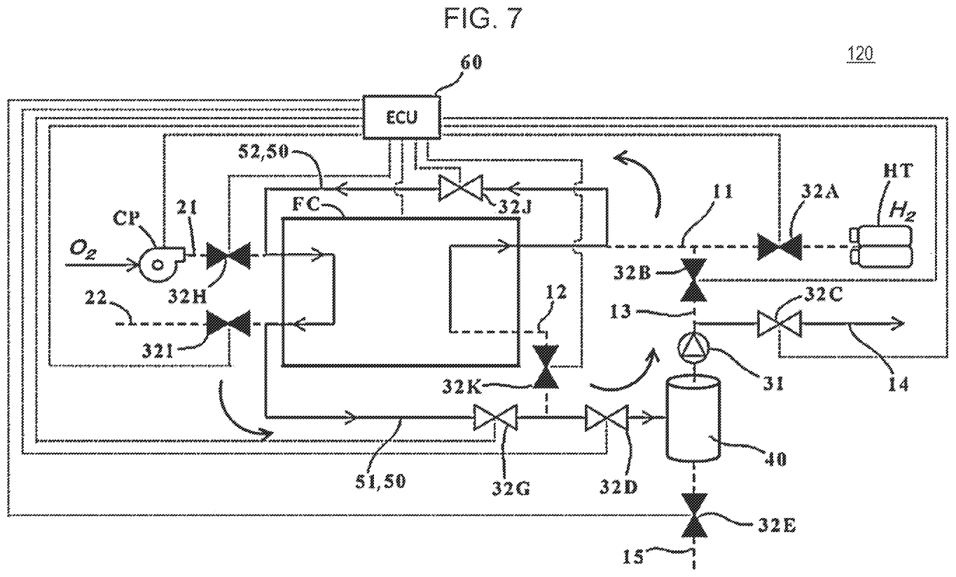

The following describes a fuel cell system 120 according to the present embodiment with reference to FIG. 7.

The fuel cell system 110 described above may include one or more of the first bypass flow path 51 and the second bypass flow path 52 by which the anode-side flow path 10 and the cathode-side flow path 20 are connected in parallel. A major feature of the present embodiment is that the fuel cell system 120 includes both the first bypass flow path 51 and the second bypass flow path 52.

The fuel cell system 120, unlike the fuel cell system 110, does not include the sixth on-off valve 32F and includes another on-off valve on the anode gas discharge path 12. Referring to FIG. 7, the fuel cell system 120 includes an eleventh on-off valve 32K, which is located between the FC and the fourth on-off valve 32D.

The following describes a series mode feasible in the fuel cell system 120 and involving the series connection of the anode-side flow path 10 and the cathode-side flow path 20.

The following describes a fifth scavenging mode in the present embodiment with reference to FIG. 7. The fifth scavenging mode is an example of the series mode involving the series connection of the anode-side flow path 10 and the cathode-side flow path 20. For example, the fifth scavenging mode is enabled by the series connection and the normal pump rotation. As illustrated in FIG. 7, the fuel cell system 120 in the present embodiment undergoes scavenging (in the fifth scavenging mode) in the state in which the anode gas intake path 11 and the cathode gas intake path 21 are connected in series with the first bypass flow path 51 and the second bypass flow path 52 located therebetween.

In one example of the series mode, the circulating pump 31 rotates in the normal direction with the anode gas intake path 11 and the cathode gas intake path 21 connected in series. In some embodiments, however, the circulating pump 31 under the control of the control device 60 rotates in the reverse direction with the anode gas intake path 11 and the cathode gas intake path 21 connected in series. This is enabled by the opening and closing of the on-off valves 32 controlled as appropriate by the control device 60.

For example, the control device 60 operates in the fifth scavenging mode when the operation of the fuel cell system 120 is temporarily stopped. As described below, scavenging in the fifth scavenging mode is the process of removing the moisture residue in the system of the FC by the application of negative pressure produced in the FC and the flow paths.

The first on-off valve 32A, the second on-off valve 32B, the fifth on-off valve 32E, the eighth on-off valve 32H, the ninth on-off valve 32I, and the eleventh on-off valve 32K are closed under the control of the control device 60, as illustrated in FIG. 7. Meanwhile, the third on-off valve 32C, the fourth on-off valve 32D, the seventh on-off valve 32G, and the tenth on-off valve 32J are open under the control of the control device 60.

As a result, the anode of the FC is cut off from a new supply of hydrogen gas (fresh gas) conveyed through the anode gas intake path 11, and the removal of anode off-gas through the anode gas discharge path 12 is stopped. The anode gas intake path 11 is linked to the cathode gas intake path 21 with the second bypass flow path 52 located therebetween. In this state, the circulating pump 31 is caused to rotate in the normal direction such that water or water vapor remaining in the anode of the FC flows backward through the anode gas intake path 11 and the second bypass flow path 52 and is then introduced into the cathode gas intake path 21.

While the anode off-gas and the moisture are introduced into the cathode gas intake path 21, the cathode is cut off from a new supply of air conveyed through the cathode gas intake path 21. Both the anode off-gas and cathode off-gas in the cathode of the FC flow through the cathode gas discharge path 22, the first bypass flow path 51, and the later stage of the anode gas discharge path 12 (the part downstream from the eleventh on-off valve 32K) under a predetermined negative pressure and are then introduced into the vapor-liquid separator 40.

Under the action of the circulating pump 31 in the fifth scavenging mode as well, the anode off-gas containing moisture and the cathode off-gas containing moisture flow through the first bypass flow path 51 and the second bypass flow path 52 and are then introduced into the vapor-liquid separator 40. The anode off-gas and the cathode off-gas introduced into the vapor-liquid separator 40 flow through the hydrogen circulation path 13 and the open-to-atmosphere discharge flow path 14 and are then discharged into the atmosphere.

As described above, the anode off-gas in the fifth scavenging mode flows through the cathode of FC and is then introduced into the vapor-liquid separator 40. As a result, water or water vapor is discharged out of the FC. Furthermore, hydrogen remains on the cathode side after the completion of scavenging in this example of the fifth scavenging mode. This inhibits deterioration of the catalyst and the like caused by oxidation on, for example, the cathode side of the FC.

The control device 60 controls the opening and closing of the on-off valves 32 so that any connection mode can be selected from among the first to fifth scavenging mode. For example, the patterns of controlling the on-off valves in accordance with the respective scavenging modes are expressed in tabular form as presented below in Table 1 and are stored in, for example, the storage device MD. The control device 60 is capable of operating in any scavenging mode at any time by controlling the opening and closing of the on-off valves 32 in accordance with the table of control patterns.

TABLE 1

| | First | Second | Third | Fourth | Fifth | Sixth | Seventh | Eighth | Ninth | Tenth | Eleventh |
|---|---|---|---|---|---|---|---|---|---|---|---|
| | On-Off | On-Off | On-Off | On-Off | On-Off | On-Off | On-Off | On-Off | On-Off | On-Off | On-Off |
| | valve | valve | valve | valve | valve | valve | valve | valve | valve | valve | valve |
| | 32A | 32B | 32C | 32D | 32E | 32F | 32G | 32H | 32I | 32J | 32K |
| First | closed | closed | open | open | closed | | | | | | |
| Scavenging | | | | | | | | | | | |
| Mode | | | | | | | | | | | |
| Second | closed | open | closed | closed | open | | | | | | |
| Scavenging | | | | | | | | | | | |
| Mode | | | | | | | | | | | |
| Third | closed | closed | open | open | closed | closed | open | closed | closed | closed | |
| Scavenging | | | | | | | | | | | |
| Mode | | | | | | | | | | | |
| Fourth | closed | open | closed | closed | open | open | closed | closed | closed | open | |
| Scavenging | | | | | | | | | | | |
| Mode | | | | | | | | | | | |
| Fifth | closed | closed | open | open | closed | | open | closed | closed | open | closed |
| Scavenging | | | | | | | | | | | |
| Mode | | | | | | | | | | | |

Although preferred embodiments of the disclosure have been described with reference to the accompanying drawings, the disclosure is not limited to the embodiments. It is obvious that further modifications may be made to the embodiments and variations thereof by those having common knowledge in the technical field of the disclosure without departing from the technical ideas set forth in the appended claims, and it is to be understood that the modifications also fall within the technical scope of the disclosure.

The disclosure enables a fuel cell system to remove, for example, moisture residue in a fuel cell when the operation of the fuel cell system is temporarily stopped.

The control device 60 illustrated in FIG. 5 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 60 including the connection mode selector 61, the valve controller 62, the pump controller 63, and the message controller 64. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 5.

1. A fuel cell system comprising:
an anode gas intake path through which anode gas is to be fed to an anode of a fuel cell, the anode gas intake path being linked to a hydrogen circulation path;
an anode gas discharge path linked to the anode;
a cathode gas intake path through which cathode gas is to be fed to a cathode of the fuel cell;
a cathode gas discharge path linked to the cathode;
a bypass flow path that links the hydrogen circulation path to the cathode gas intake path and/or the cathode gas discharge path;
a circulating pump disposed on the hydrogen circulation path;
on-off valves comprising an on-off valve on the anode gas intake path, an on-off valve on the anode gas discharge path, and an on-off valve on the bypass flow path; and
a control device configured to control the on-off valves and operation of the circulating pump, the control device being configured to cause the circulating pump to rotate in a normal direction or a reverse direction in a selective manner during control of the on-off valves to discharge water or water vapor out of the fuel cell.

2. The fuel cell system according to claim 1, wherein
the bypass flow path links the hydrogen circulation path to the cathode gas intake path and the cathode gas discharge path, and
the circulating pump is configured to be driven to discharge water or water vapor out of the anode gas intake path and the cathode gas intake path.

3. The fuel cell system according to claim 2, wherein the anode gas intake path and the cathode gas intake path are connected in series with the bypass flow path located therebetween.

4. The fuel cell system according to claim 1, wherein
the anode gas intake path and the cathode gas intake path are connected in parallel with the bypass flow path located therebetween, or
the anode gas discharge path and the cathode gas discharge path are connected in parallel with the bypass flow path located therebetween.

5. The fuel cell system according to claim 1, further comprising an outside air temperature sensor configured to measure outside air temperature, wherein
the control device is configured to, based on information about the outside air temperature measured by the outside air temperature sensor, switch a connection of an anode-side flow path and a cathode-side flow path from a series connection to a parallel connection or from the parallel connection to the series connection to discharge the water or water vapor out of the fuel cell.

6. The fuel cell system according to claim 2, further comprising an outside air temperature sensor configured to measure outside air temperature, wherein
the control device is configured to, based on information about the outside air temperature measured by the outside air temperature sensor, switch a connection of an anode-side flow path and a cathode-side flow path from a series connection to a parallel connection or from the parallel connection to the series connection to discharge the water or water vapor out of the fuel cell.

7. The fuel cell system according to claim 3, further comprising an outside air temperature sensor configured to measure outside air temperature, wherein
the control device is configured to, based on information about the outside air temperature measured by the outside air temperature sensor, switch a connection of an anode-side flow path and a cathode-side flow path from a series connection to a parallel connection or from the parallel connection to the series connection to discharge the water or water vapor out of the fuel cell.

8. The fuel cell system according to claim 4, further comprising an outside air temperature sensor configured to measure outside air temperature, wherein
the control device is configured to, based on information about the outside air temperature measured by the outside air temperature sensor, switch a connection of an anode-side flow path and a cathode-side flow path from a series connection to a parallel connection or from the parallel connection to the series connection to discharge the water or water vapor out of the fuel cell.
